(19) United States
(12) Patent Application Publication
(10) Pub. No.: US 2025/0316800 A1
(43) Pub. Date: Oct. 9, 2025

(54) HYBRID BATTERY CELL ENCLOSURE

(71) Applicant: GM Global Technology Operations LLC, Detroit, MI (US)

(72) Inventor: Seung-Woo Chu, Sterling Heights, MI (US)

(21) Appl. No.: 18/626,773

(22) Filed: Apr. 4, 2024

(51) Int. Cl. H01M 50/129; H01M 50/105; H01M 50/119; H01M 50/571

(52) U.S. Cl. CPC H01M 50/129; H01M 50/105; H01M 50/119; H01M 50/571

(57) ABSTRACT

A battery cell including an anode layer, a cathode layer and a separator positioned between the anode layer and the cathode layer, the anode layer, the cathode layer and the separator positioned within a hybrid battery cell enclosure having an aluminum alloy metal sheet and a multi-layer aluminum laminate film, wherein, the multi-layer aluminum laminate film and the aluminum alloy metal sheet are bonded to one another around a perimeter of the hybrid battery cell enclosure defining a sealed cavity between the multi-layer aluminum laminate film and the aluminum alloy metal sheet and within the perimeter of the hybrid battery cell, the anode layer, the cathode layer, and the separator positioned within the sealed cavity.

### INTRODUCTION

The present invention relates generally to a hybrid battery cell enclosure for an electrochemical energy storage device such as a Li-ion battery cell, and more particularly to a hybrid battery cell enclosure having an aluminum alloy metal sheet bonded to a multi-layer aluminum laminate film around a perimeter thereof.

Pouch cells do not have a rigid enclosure and instead use a sealed flexible foil as the cell container. This packaging reduces weight and leads to flexible cells that can easily fit the available space of a given product, however, pouch cells can easily swell due to gassing over the life of the battery cell. Further, due to the cell's soft construction, a support structure is required with pouch cells and the cell should not be placed near sharp edges. Finally, pouch type enclosures do not generally provide for a designated vent.

Thus, while current battery cell enclosures achieve their intended purpose, there is a need for a new and improved hybrid battery cell enclosure comprising an aluminum alloy metal sheet bonded to a multi-layer aluminum laminate film around a perimeter thereof.

### SUMMARY

According to several aspects of the present disclosure, a hybrid battery cell enclosure includes an aluminum alloy metal sheet, and a multi-layer aluminum laminate film, wherein, the multi-layer aluminum laminate film and the aluminum alloy metal sheet are bonded to one another around a perimeter of the hybrid battery cell enclosure defining a sealed cavity between the multi-layer aluminum laminate film and the aluminum alloy metal sheet and within the perimeter of the battery cell that is adapted to house components of a battery cell.

According to several aspects of the current disclosure, a battery cell includes an anode layer, a cathode layer and a separator positioned between the anode layer and the cathode layer, the anode layer, the cathode layer and the separator positioned within a hybrid battery cell enclosure having an aluminum alloy metal sheet, and a multi-layer aluminum laminate film, wherein, the multi-layer aluminum laminate film and the aluminum alloy metal sheet are bonded to one another around a perimeter of the hybrid battery cell enclosure defining a sealed cavity between the multi-layer aluminum laminate film and the aluminum alloy metal sheet and within the perimeter of the battery cell, the anode layer, the cathode layer, and the separator positioned within the sealed cavity.

According to another aspect, the multi-layer aluminum laminate film comprises an outer layer of plastic material, a middle layer comprising one of aluminum or an aluminum alloy, and an inner layer comprising polypropylene (PP), wherein, the inner layer of the multi-layer aluminum laminate film is bonded to the aluminum alloy metal sheet around the perimeter of the hybrid battery cell enclosure.

According to another aspect, the inner layer of the multi-layer aluminum laminate film is at least one of heat-sealed to the aluminum alloy metal sheet around the perimeter of the hybrid battery cell enclosure, and bonded to the aluminum alloy metal sheet around the perimeter of the hybrid battery cell enclosure by grafting of a triazine molecular layer therebetween.

According to another aspect, the aluminum alloy metal sheet includes at least one flange portion that is folded over onto the multi-layer aluminum laminate film and extending at least partially along the perimeter of the hybrid battery cell enclosure.

According to another aspect, the outer perimeter of the hybrid battery cell enclosure includes a segment wherein the aluminum alloy metal sheet does not include a flange portion folded over onto the multi-layer aluminum laminate film, such segment defining a vent.

According to another aspect, the aluminum alloy metal sheet includes a first protruding element extending through the inner PP layer and into the middle layer of the multi-layer aluminum laminate film, creating an electrical circuit between the aluminum alloy metal sheet and the middle layer of the multi-layer aluminum laminate film.

According to another aspect, the battery cell further includes an anode current collector adjacent the anode layer and including an anode lead tab comprising one of graphite, carbon, silicone, tin, lithium or aluminum and extending between the aluminum alloy metal sheet and the multi-layer aluminum laminate film out of the sealed cavity, a cathode current collector adjacent the cathode layer and including a cathode lead tab extending between the aluminum alloy metal sheet and the multi-layer aluminum laminate film out of the sealed cavity, the cathode lead tab including a cathode lead tab film including one of carbon black or conductive thermally stable polymer beads, and the aluminum alloy metal sheet includes a second protruding element adapted to contact the cathode lead tab and creating a high resistance electrical circuit between the aluminum alloy metal sheet and the cathode lead tab.

According to another aspect, the anode current collector and the anode lead tab are made from one of silicone or a lithium alloy, wherein the anode current collector and the anode lead tab will exhibit more severe expansion/compression during charging and discharging as compared to other materials, such as graphite.

According to several aspects of the present disclosure, a vehicle includes at least one battery cell adapted to store electric energy for the vehicle, the battery cell comprising an anode layer having an anode lead tab comprising one of graphite, carbon, silicone, tin, lithium or aluminum, a cathode layer having a cathode lead tab and a separator positioned between the anode layer and the cathode layer, the anode layer, the cathode layer and the separator positioned within a hybrid battery cell enclosure having an aluminum alloy metal sheet, and a multi-layer aluminum laminate film including an outer layer of plastic material, a middle layer comprising one of aluminum or an aluminum alloy, and an inner layer comprising polypropylene (PP), wherein, the inner layer of the multi-layer aluminum laminate film and the aluminum alloy metal sheet are bonded to one another around a perimeter of the hybrid battery cell enclosure defining a sealed cavity between the multi-layer aluminum laminate film and the aluminum alloy metal sheet and within the perimeter of the hybrid battery cell, the anode layer, the cathode layer, and the separator positioned within the sealed cavity, and each of the anode lead tab and the cathode lead tab extending between the aluminum alloy metal sheet and the multi-layer aluminum laminate film out of the sealed cavity.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a vehicle having at least one battery cell in accordance with an exemplary embodiment of the present disclosure;

FIG. 2 is a top view of a hybrid battery cell enclosure in accordance with an exemplary embodiment;

FIG. 3 is a sectional view of the hybrid battery cell enclosure taken along line 3-3 in FIG. 2;

FIG. 4 is a schematic view of the battery components that form a stack within a sealed cavity of the hybrid battery cell enclosure;

FIG. 5 is a sectional view taken along line 5-5 of FIG. 2;

FIG. 6 is a schematic view of a multi-layer aluminum laminate film being brought into contact with a aluminum alloy metal sheet;

FIG. 7 is a sectional view taken along line 7-7 of FIG. 8, wherein the flange portions of the aluminum alloy metal sheet have not been folded over onto the multi-layer aluminum laminate film;

FIG. 8 is a top view of the hybrid battery cell enclosure wherein the flange portions of the aluminum alloy metal sheet have not been folded over onto the multi-layer aluminum laminate film;

FIG. 9 is a sectional view taken along line 9-9 of FIG. 2, wherein a segment of the hybrid battery cell enclosure does not include a flange portion folded over onto the multi-layer aluminum laminate film and defines a vent;

FIG. 10 is the sectional view of FIG. 9, wherein, pressure within the sealed cavity of the hybrid battery cell enclosure has caused the vent to allow gases to escape from the sealed cavity;

FIG. 11 is a side view of the battery cell as gases from within the sealed cavity are expelled through the vent;

FIG. 12 is sectional view taken along line 12-12 of FIG. 2, wherein the cathode lead tab extends from the cathode current collector out from the sealed cavity between the multi-layer aluminum laminate film and the aluminum alloy metal sheet;

FIG. 13 is a sectional view taken along line 13-13 of FIG. 14, wherein flange portions along the sides of the battery cell have been folded over an additional ninety degrees; and

FIG. 14 is a top view of the battery cell wherein flange portions along the sides of the battery cell have been folded over an additional ninety degrees to reduce the overall width of the battery cell.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and non-vehicle related consumer electronic components.

Lithium-ion batteries and battery cells generally take on one of three traditional forms, cylindrical, prismatic, and pouch types. Each of these battery types offers a set of advantages and disadvantages. The type of battery determines many production factors, for example, each battery form may have a different temperature distribution and heat transfer model.

A cylindrical cell consists of sheet-like anodes, separators, and cathodes that are sandwiched, rolled up, and packed into a cylinder-shaped can. This type is one of the first mass-produced types of batteries. Cylindrical cells are well suited for automated manufacturing and provide good mechanical stability. The round shape of the battery distributes internal pressure from side reactions over the cell circumference almost evenly, allowing the cell to tolerate a higher level of internal pressure without deformation. However, when combining cylindrical cells into packs and modules, the cell's circular cross-section does not allow full utilization of available space, and, as a result, the packaging density of cylindrical cells is low. However, thermal management of a pack of cylindrical cells can be easier because space cavities allow coolant to easily circulate around the cells within a battery pack.

Prismatic cells consist of large sheets of anodes, cathodes, and separators sandwiched, rolled up, and pressed to fit into a metallic or hard-plastic housing in cubic form. The electrodes can also be assembled by layer stacking rather than jelly rolling. Parts of the electrode and separator sheets of a prismatic cell that are close to the container corners can experience more stress. This can damage electrode coatings and lead to non-uniform distribution of the electrolyte. When combining prismatic cells into packs, the cell box-like shape enables optimal use of available space, however, this efficient use of space is achieved with less efficient thermal management because there are no space cavities between the cells as there are in a pack of cylindrical cells.

Pouch cells do not have a rigid enclosure and instead use a sealed flexible foil as the cell container. This packaging reduces weight and leads to flexible cells that can easily fit the available space of a given product, however, pouch cells can easily swell due to gassing over the life of the battery cell. Further, due to the cell's soft construction, a support structure is required with pouch cells and the cell should not be placed near sharp edges. To apply stack pressure during cell manufacturing and during battery cell 11 use, pouch type enclosures are often used for cell designs with high content of silicone or lithium (optionally including SSE) on the anode. However, pouch type enclosures do not provide a designated vent.

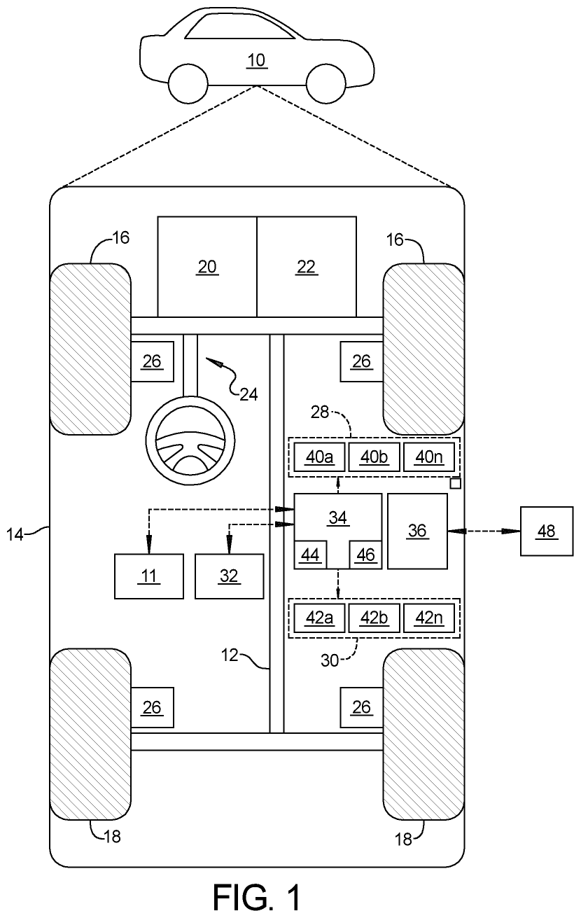

In accordance with an exemplary embodiment of the present disclosure, FIG. 1 shows a vehicle 10 with an associated battery cell 11 for storing and supplying electrical energy to the vehicle 10. It should be understood by those skilled in the art that the battery cell 11 may be part of a battery system including multiple battery cells 11 working together and connected in parallel or in series to provide electrical power to the vehicle 10. In general, the battery cell 11 works in conjunction with other systems within the vehicle 10 to provide power to either or both an electric propulsion system within the vehicle and/or the various systems within the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle and the system 11 is incorporated into the autonomous vehicle 10. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles.

As shown, the vehicle 10 generally includes a propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, the propulsion system may include one or more electric motors that are connected to and powered by the battery cell 11, and there may be no transmission system 22. The propulsion system 20 may, in various embodiments, include an internal combustion engine, an electric machine such as a traction motor, and/or a fuel cell propulsion system. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

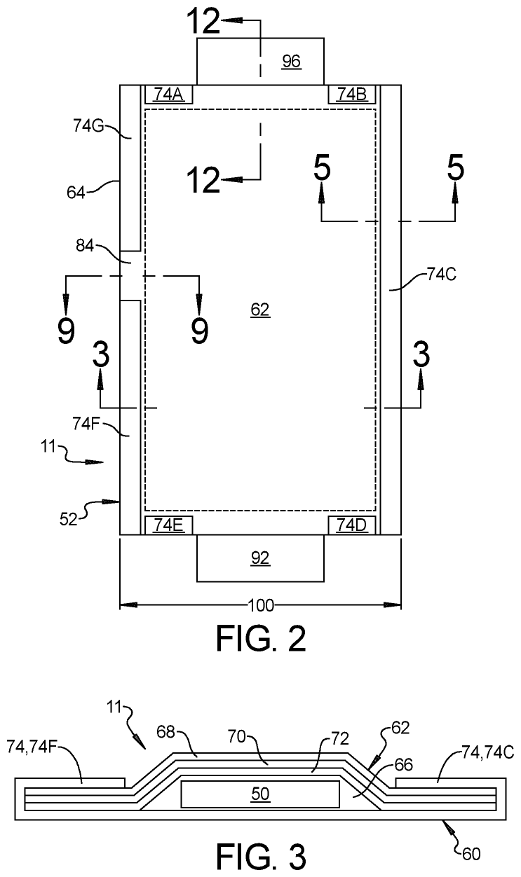

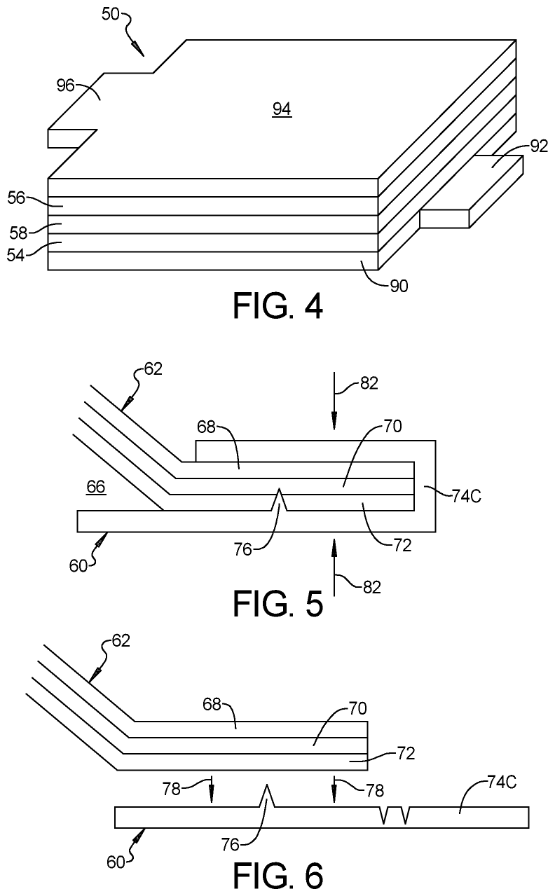

Referring to FIG. 2, FIG. 3 and FIG. 4, a battery cell 11 in accordance with embodiments of the present disclosure includes battery cell components 50 that are positioned within a hybrid battery cell enclosure 52. Referring to FIG. 4, battery components 50 includes at least an anode layer 54, a cathode layer 56 and a separator 58 positioned between the anode layer 54 and the cathode layer 56. As shown, the battery cell components 50 include a single anode layer 54 and a single cathode layer 56, however, it should be understood by those skilled in the art that the battery cell components 50 of the battery cell 11 may include multiple alternating anode and cathode layers 54, 56 and separators 58 that are stacked and connected in parallel or in series within the battery cell 11. As shown, the battery cell 11 is a lithium-ion (LI-ION) battery cell. It should be understood that the novel features of the present disclosure are applicable to any type of battery cell 11 incorporating an enclosure within which battery components 50 of a battery cell 11 are housed, as well as to non-LI-ION battery cells.

In an exemplary embodiment, the separator 58 is made from a porous polyolefin comprising one of polyethylene (PE), polypropylene (PP), or a PE/PP hybrid. The separator 58 is used to contain electrolyte and prevent physical contact (electron-conducting contact) between the anode layer 54 and the cathode layer 56. A lithium-ion battery cell generally operates by reversibly passing lithium ions between a negative electrode (anode layer 54) and a positive electrode (cathode layer 56). The separator 58 is soaked with an electrolyte solution suitable for conducting lithium ions back and forth between the anode layer 54 and the cathode layer 56. Each of the anode layer 54 and the cathode layer 56 are further carried on or connected to a metallic current collector (typically copper for the anode layer 54 and aluminum for the cathode layer 56). During battery usage, the current collectors associated with the anode layer 52 and the cathode layer 54 are connected by a controllable and interruptible external circuit that allows an electron current to pass between the anode layer 52 and the cathode layer 54 to electrically balance the related transport of lithium ions through the battery cell 50. Many different materials may be used to produce these various components of a lithium-ion battery. But in general, the anode layer 54 typically comprises a lithium insertion material or alloy host material, the cathode layer 56 typically comprises a lithium-containing active material that can store lithium at higher potential (relative to a lithium metal reference electrode) than the host material of the anode layer 54, and the electrolyte solution typically contains one or more lithium salts dissolved and ionized in a non-aqueous solvent. The contact of the anode layer 54 and the cathode layer 56 with the electrolyte results in an electrical potential between the anode layer 54 and the cathode layer 56 and, when an electron current is exploited in an external circuit between the anode layer 54 and the cathode layer 56, the potential is sustained by electrochemical reactions within the battery cell 11.

The lithium-ion battery cell 11, or a plurality of lithium-ion battery cells 11 that are connected in a series or a parallel arrangement (or any suitable combination thereof) for current flow, can be utilized to reversibly supply power to an associated load device. The battery system delivers electrical power on demand to a load device such as an electric motor until the lithium content of the anode layer 54 (negative electrode) has been depleted to a predetermined level. The battery cell 11 may then be re-charged by passing a suitable direct electrical current in the opposite direction between the anode layer 54 and the cathode layer 56.

At the beginning of the discharge, the anode layer 54 contains a high concentration of intercalated lithium while the cathode layer 56 is relatively depleted. The establishment of a closed external circuit between the anode layer 54 and the cathode layer 56 under such circumstances causes the transport of intercalated lithium from the anode layer 54. The intercalated lithium is oxidized into lithium ions and electrons. The lithium ions are carried from the anode layer 54 (negative electrode) to the cathode layer 56 (positive electrode) through the ionically conductive electrolyte solution contained in the pores of the porous polyolefin separator 58 while, at the same time, the released electrons are transmitted through the external circuit from the anode layer 54 (negative electrode) to the cathode layer 56 (positive electrode) (with the help of the current collectors), to balance the overall reaction occurring in the electrochemical battery cell 11. The lithium ions are assimilated into the material of the cathode layer 56 by an electrochemical reduction reaction. The flow of electrons through the external circuit can power a load device until the level of intercalated lithium in the anode layer 54 falls below a workable level or the need for power ceases.

The battery cell 11 may be recharged after a partial or full discharge of its available capacity. To charge or re-power the lithium-ion battery cell 11, an external power source is connected to the cathode layer 56 and the anode layer 54 to drive the reverse of battery discharge electrochemical reactions. That is, during charging, the lithium within the cathode layer 56 is oxidized to yield lithium cations and electrons. The cations transport across the separator 58 to the anode layer 54, and the electrons travel through the external circuit to the anode layer 54 as well. At the surface of the anode layer 54, the lithium cations are reduced to lithium by combining with the available electrons within the anode layer 54, and the lithium content of the anode layer 54 increases. Overall, the charging process reduces the lithium content within the cathode layer 56 and increases the lithium content within the anode layer 54.

The separator 58 serves an important function in the battery cell 11. In many lithium-ion battery constructions the anode layer 54 and the cathode layer 56 are formed as thin, compacted, polymer bonded, particulate material layers on their respective current collectors (for example, copper or aluminum foils) and each cell 11 is assembled with a thin, porous, polyolefin separator 58 inserted between the facing electrode layers. Thus, the pores and surfaces of the separator 58 are filled and contacted with a lithium ion-containing, non-aqueous electrolyte that contacts and wets the facing anode layer 54 and cathode layer 56 to enable the flow of lithium ions and counter-ions through the pores of the separator 58 and between the anode layer 54 and cathode layer 56. But the polymeric separator 58 resists the flow of electrons directly between the anode layer 54 and the cathode layer 56.

Referring to FIG. 3, the battery cell components 50, including the anode layer 54, the cathode layer 56 and the separator 58 are positioned within the hybrid battery cell enclosure 52. The hybrid battery cell enclosure 53 includes an aluminum alloy metal sheet 60 and a multi-layer aluminum laminate film 62. The multi-layer aluminum laminate film 62 and the aluminum alloy metal sheet 60 are bonded to one another around a perimeter 64 of the hybrid battery cell enclosure 52 defining a sealed cavity 66 between the multi-layer aluminum laminate film 62 and the aluminum alloy metal sheet 60 and within the perimeter 64 of the battery cell 11. The battery cell components 50, including the anode layer 54, the cathode layer 56, and the separator 58 are positioned within the sealed cavity 66. The multi-layer aluminum laminate film 62 provides the advantages of a flexible, thin, lightweight pouch style battery cell enclosure, that can expand to accommodate pressure/temperature increases, and the aluminum alloy metal sheet 60 provides rigid support and protection, overcoming the disadvantages associated with a traditional pouch style battery cell enclosure.

In an exemplary embodiment, the multi-layer aluminum laminate film 62 includes an outer layer 68 of plastic material, a middle layer 70 comprising one of aluminum or an aluminum alloy, and an inner layer 72 comprising polypropylene (PP). The inner layer 72 of the multi-layer aluminum laminate film 62 is bonded to the aluminum alloy metal sheet 60 around the perimeter 64 of the hybrid battery cell enclosure 52.

The inner layer 72 of the multi-layer aluminum laminate film 62 may be bonded to the aluminum alloy metal sheet 60 by any suitable means known for doing so. In an exemplary embodiment, the inner layer 72 of the multi-layer aluminum laminate film 62 is at least one of 1) heat-sealed to the aluminum alloy metal sheet 60 around the perimeter 64 of the hybrid battery cell enclosure 52, and 2) bonded to the aluminum alloy metal sheet 60 around the perimeter 64 of the hybrid battery cell enclosure 52 by grafting of a triazine molecular layer therebetween. Bonding of polypropylene to aluminum in this way is described in an article published by American Chemical Society entitled “Direct Bonding of Polypropylene to Aluminum Using Molecular Connection and the Interface Nanoscale Properties” (ACS Appl. Polym. Mater. 2019, 1, 9, 2450-2459), authored by Jing Sang, Hidetoshi Hirahara, Sumio Aisawa, Zhixin Kang, and Kunio Mori, and first published by the American Chemical Society on Aug. 19, 2019, which is incorporated herein by reference. For easier assembly and manufacturability, a thin film of PP can be attached around the seal perimeter 64 of the aluminum alloy metal sheet 60 of the hybrid battery cell enclosure 52, first by grafting of a triazine molecular layer formation and then heat sealing. Then the PP layer of the multi-layer aluminum laminate film 62 can be bonded, by heat sealing, to the thin film of PP that is pre-bonded to the aluminum alloy metal sheet 60. Thus, the heat seal is applied to bond the same material. This allows the battery cell 11 to be manufactured using existing pouch sealing processes. Further, in an exemplary embodiment, the aluminum alloy metal sheet 60 includes a shallow deep drawing adapted accommodate a thick electrode assembly. Generally forming of a pouch film in this way is limited due to the thin Al layer of the pouch film, but incorporation of the aluminum alloy metal sheet 60 of the present disclosure allows formation of the deeper space.

Referring to FIG. 5 a sectional view of FIG. 2 taken along line 5-5 in FIG. 2 is shown. In an exemplary embodiment, the aluminum alloy metal sheet 60 includes at least one flange portion 74 that is folded over onto the multi-layer aluminum laminate film 62 and extends at least partially along the perimeter 64 of the hybrid battery cell enclosure 52. As shown in FIG. 5, the hybrid battery cell enclosure 52 includes seven individual flange portions 74A, 74B, 74C, 74D, 74E, 74F, 74G that extend substantially around the entire perimeter 64 with three exceptions that will be discussed below.

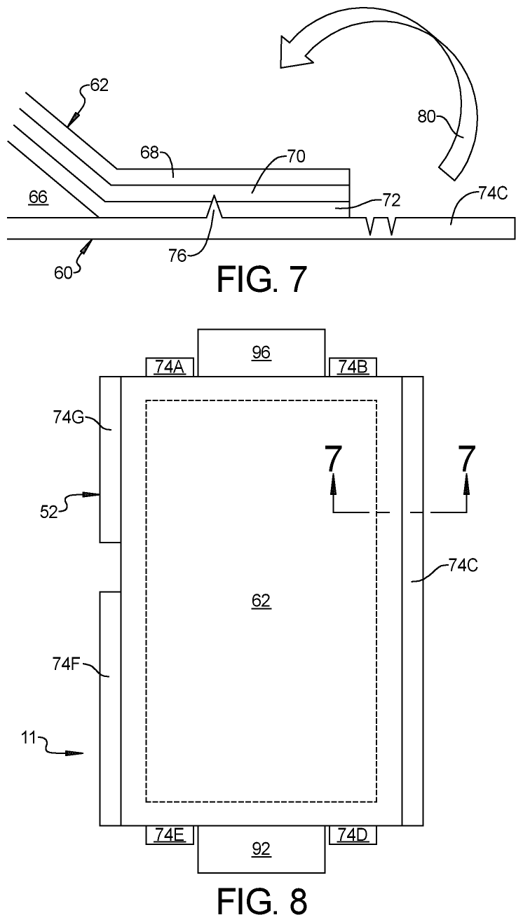

In another exemplary embodiment, the aluminum alloy metal sheet 60 includes a first protruding element 76 extending through the inner PP layer 72 and into the middle layer 70 of the multi-layer aluminum laminate film 62, creating an electrical circuit between the aluminum alloy metal sheet 60 and the middle layer 70 of the multi-layer aluminum laminate film 62. Mechanical damage (micro-crack formation) to the inner layer 72 of the multi-layer aluminum laminate film 62 causes galvanic corrosion when the aluminum middle layer 70 is exposed to the potential of the anode layer 54. Micro-crack formation is more of a concern when the battery cell uses silicone or lithium alloys because these alloys expand and contract significantly more that other elements, such as graphite. If the aluminum middle layer 70 of the multi-layer aluminum laminate film has cathode potential, corrosion of the aluminum middle layer 70 is prevented as a robust layer of aluminum fluoride (AlF3) is formed when the aluminum middle layer 70 is exposed to electrolyte that seems in through micro-cracks in the PP inner layer 68. Positive polarity of the aluminum middle layer 70 is achieved when the first protruding element creates an electric circuit between the aluminum middle layer 70 and the aluminum alloy metal sheet 60, wherein the aluminum middle layer 70 will have the same polarity as the aluminum alloy metal sheet 60. Referring to FIG. 6, the aluminum alloy metal sheet 60 includes a first protruding element 76 comprising a sharp protruding point or ridge extending upward from the aluminum alloy metal sheet 60. The multi-layer aluminum laminate film 62 is brought into contact with the aluminum alloy metal sheet 60 as indicated by arrows 78. Referring to FIG. 7, when the multi-layer aluminum laminate film 62 is forced downward to contact the aluminum alloy metal sheet 60, the first protruding element 76 pierces the inner PP layer 72 and extends into the middle layer 70 of the multi-layer aluminum laminate film 62, wherein an electrical circuit is established between the middle layer 70 of the multi-layer aluminum laminate film 62 and the aluminum alloy metal sheet 60. As discussed above, after the multi-layer aluminum laminate film 62 is forced downward to contact the aluminum alloy metal sheet 60, and the inner layer 72 of the multi-layer aluminum laminate film 62 is bonded to the aluminum alloy metal sheet 60 around the entire perimeter 64 of the hybrid battery cell enclosure 52, and the flange portion 74 of the aluminum alloy metal sheet 60 is folded over, as indicated by arrow 80, until the flange portion contacts the outer layer 68 of the multi-layer aluminum laminate film 62 and provides added pressure, as indicated by arrows 82 in FIG. 5, to keep the multi-layer aluminum laminate film 62 sealed to the aluminum alloy metal sheet 60.

Referring to FIG. 8, a top view of the hybrid battery cell enclosure 52 shows the multi-layer aluminum laminate film positioned on top of the aluminum alloy metal sheet 60. As shown in FIG. 8, flange portions 74A, 74B, 74C, 74D, 74E, 74F, 74G are still extending outward from the aluminum alloy metal sheet 60 and have not been folded over onto the multi-layer aluminum laminate film. Referring again to FIG. 2, the top view of the hybrid battery cell enclosure 52 is shown wherein, all of the flange portions 74A, 74B, 74C, 74D, 74E, 74F, 74G have been folder over as indicated in FIG. 7 and FIG. 5.

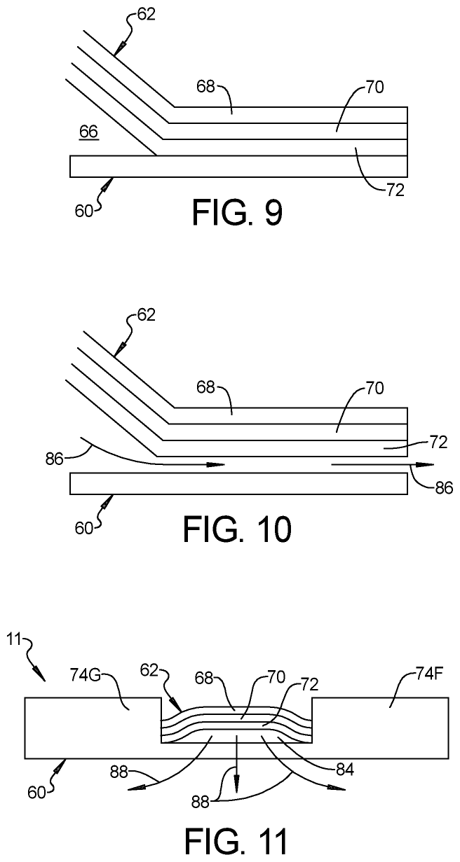

As mentioned previously, the hybrid battery cell enclosure 52 includes seven individual flange portions 74A, 74B, 74C, 74D, 74E, 74F, 74G that extend substantially around the entire perimeter 64 with three exceptions. Referring to FIG. 9, a sectional view of FIG. 2 taken along line 9-9 in FIG. 2 is shown. In an exemplary embodiment the outer perimeter 64 of the hybrid battery cell enclosure 52 includes a segment wherein the aluminum alloy metal sheet 60 does not include a flange portion 74 folded over onto the multi-layer aluminum laminate film 62, such segment defines a vent 84. The hybrid battery cell enclosure is a sealed enclosure which has to be equipped with a pressure release vent 84. The vent 84 protects the battery cell 11 against temperature and pressure fluctuations that occur due to chemical reactions, such as redox and decomposition, that take place within the battery cell 11. The vent 84 prevents the buildup of gases, internal pressure, and temperature by allowing them to escape into the external atmosphere, thus ensuring the battery cell's safety and longevity.

Within the segment that defines the vent 84, the inner layer 72 of the multi-layer aluminum laminate film 62 is bonded (by heat sealing or otherwise) to the aluminum alloy metal sheet 60. However, the absence of a flange portion 74 extending over onto the outer layer 68 of the multi-layer aluminum laminate film 62 to provide added pressure to keep the multi-layer aluminum laminate film 62 bonded to the aluminum alloy metal sheet 60, the vent 84 provides a weak spot that will fail, in a controlled manner. Referring to FIG. 10, this means that the type of bonding between the multi-layer aluminum laminate film 62 and the aluminum alloy metal sheet 60 can be designed to allow the bond therebetween to break under a pre-determined pressure and/or temperature, allowing high temperature/high pressure gases to escape, as indicted by arrows 86. Thus, the vent 84 provides a controlled failure that will allow high temperature and/or high pressure gases to escape from the sealed cavity 66 of the hybrid battery cell enclosure 52. Referring to FIG. 11, a side view of the hybrid battery cell enclosure 52 shows the vent 84, positioned between flange portions 74F, 74G, wherein, when the temperature/pressure within the sealed cavity 66 reaches a pre-determined limit, the bonding between the inner layer 72 of the multi-layer aluminum laminate film 62 and the aluminum alloy metal sheet 60 fails and allows the multi-layer aluminum laminate film 62 to separate from the aluminum alloy metal sheet 60, providing a pathway for high temperature/high pressure gases to escape, as indicated by arrows 88.

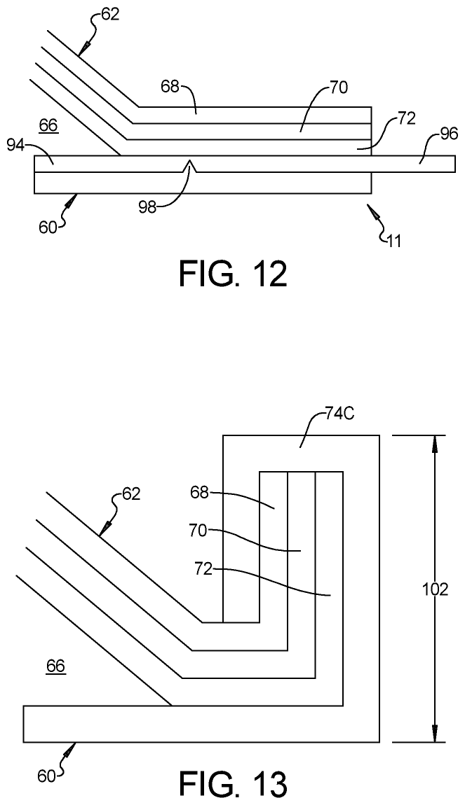

Referring again to FIG. 4, in an exemplary embodiment, the battery cell components 50 within the sealed cavity 66 of the hybrid battery cell enclosure 52 include an anode current collector 90 adjacent the anode layer 54 and including an anode lead tab 92 comprising one of graphite, carbon, silicone, tin, lithium or aluminum and extending between the aluminum alloy metal sheet 60 and the multi-layer aluminum laminate film 62 out of the sealed cavity 66, and a cathode current collector 94 adjacent the cathode layer 56 and including a cathode lead tab 96 extending between the aluminum alloy metal sheet 60 and the multi-layer aluminum laminate film 62 out of the sealed cavity 66. Referring to FIG. 12, a sectional view of FIG. 2, taken along line 12-12 of FIG. 2 shows the cathode lead tab 96 extending out of the sealed cavity 66 between the multi-layer aluminum laminate film 62 and the aluminum alloy metal sheet 60. The inner layer 72 of the multi-layer aluminum laminate film 62 and the aluminum alloy metal sheet 60 are bonded (by heat sealing or otherwise) to opposite sides of the cathode lead tab 96 at the perimeter 64 of the hybrid battery cell enclosure 52. The anode lead tab 92 extends from an opposite end of the battery cell 11 and is bonded to the multi-layer aluminum laminate film 62 and the aluminum alloy metal sheet 60, similarly to the cathode lead tab 96.

In an exemplary embodiment, as shown in FIG. 12, the aluminum alloy metal sheet 60 includes a second protruding element 98 adapted to contact the cathode lead tab 96. Referring again to FIG. 12, the aluminum alloy metal sheet 60 includes a second protruding element 98 that comprises a short sharp point or ridge that engages the cathode lead tab 96 and creates an electric circuit between the cathode lead tab 96 and the aluminum alloy metal sheet 60. To create a circuit with high resistance, the cathode lead tab contains a film containing carbon black or conductive thermally stable polymer beads.

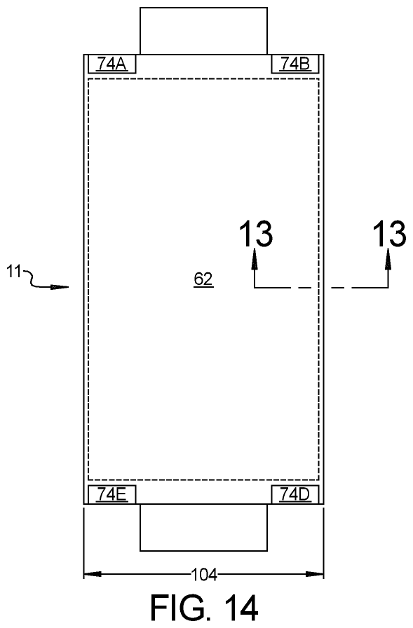

Referring to FIG. 13, in another exemplary embodiment, the flange portions 74C, 74F, 74G are, after the flange portions 74C, 74F, 74G are folded over onto the outer layer 68 of the multi-layer aluminum laminate film 62, folded over an additional ninety degrees to decrease an overall width of the battery cell 11. Referring again to FIG. 2, when the flange portions 74C, 74F, 74G are folded over onto the outer layer 68 of the multi-layer aluminum laminate film 62, the battery cell 11 has a first overall width 100. Referring to FIG. 13, after the flange portions 74C, 74F, 74G are folded over an additional ninety degrees, the first overall width 100 of the battery cell 11 is reduced by the length 102 of the flange portions 74C, 74F, 74G on each side of the battery cell 11, such that, referring to FIG. 14, the overall width of the battery cell 11 is reduced from the first overall width 100 to a second overall width 104 that is less than the first overall width by twice the distance 102.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A hybrid battery cell enclosure, comprising:
an aluminum alloy metal sheet; and
a multi-layer aluminum laminate film;
wherein, the multi-layer aluminum laminate film and the aluminum alloy metal sheet are bonded to one another around a perimeter of the hybrid battery cell enclosure defining a sealed cavity between the multi-layer aluminum laminate film and the aluminum alloy metal sheet and within the perimeter of the battery cell that is adapted to house components of a battery cell.

2. The hybrid battery cell enclosure of claim 1, wherein the multi-layer aluminum laminate film comprises:
an outer layer of plastic material;
a middle layer comprising one of aluminum or an aluminum alloy; and
an inner layer comprising polypropylene (PP),
wherein, the inner layer of the multi-layer aluminum laminate film is bonded to the aluminum alloy metal sheet around the perimeter of the hybrid battery cell enclosure.

3. The hybrid battery cell enclosure of claim 2, wherein the inner layer of the multi-layer aluminum laminate film is at least one of:
heat-sealed to the aluminum alloy metal sheet around the perimeter of the hybrid battery cell enclosure; and
bonded to the aluminum alloy metal sheet around the perimeter of the hybrid battery cell enclosure by grafting of a triazine molecular layer therebetween.

4. The hybrid battery cell enclosure of claim 2, wherein the aluminum alloy metal sheet includes at least one flange portion that is folded over onto the multi-layer aluminum laminate film and extending at least partially along the perimeter of the hybrid battery cell enclosure.

5. The hybrid battery cell enclosure of claim 4, wherein the outer perimeter of the hybrid battery cell enclosure includes a segment wherein the aluminum alloy metal sheet does not include a flange portion folded over onto the multi-layer aluminum laminate film, such segment defining a vent.

6. The hybrid battery cell enclosure of claim 4, wherein the aluminum alloy metal sheet includes a first protruding element extending through the inner PP layer and into the middle layer of the multi-layer aluminum laminate film, creating an electrical circuit between the aluminum alloy metal sheet and the middle layer of the multi-layer aluminum laminate film.

7. The hybrid battery cell enclosure of claim 6, wherein the aluminum alloy metal sheet includes a second protruding element adapted to contact a cathode lead tab of a battery cell housed within the hybrid battery cell enclosure and create a high resistance electrical circuit between the aluminum alloy metal sheet and the cathode lead tab.

8. A battery cell, comprising:
an anode layer, a cathode layer and a separator positioned between the anode layer and the cathode layer, the anode layer, the cathode layer and the separator positioned within a hybrid battery cell enclosure having:
an aluminum alloy metal sheet; and
a multi-layer aluminum laminate film;
wherein, the multi-layer aluminum laminate film and the aluminum alloy metal sheet are bonded to one another around a perimeter of the hybrid battery cell enclosure defining a sealed cavity between the multi-layer aluminum laminate film and the aluminum alloy metal sheet and within the perimeter of the battery cell, the anode layer, the cathode layer, and the separator positioned within the sealed cavity.

9. The battery cell of claim 8, wherein the multi-layer aluminum laminate film comprises:
an outer layer of plastic material;
a middle layer comprising one of aluminum or an aluminum alloy; and
an inner layer comprising polypropylene (PP),
wherein, the inner layer of the multi-layer aluminum laminate film is bonded to the aluminum alloy metal sheet around the perimeter of the hybrid battery cell enclosure.

10. The battery cell of claim 9, wherein the inner layer of the multi-layer aluminum laminate film is at least one of:
heat-sealed to the aluminum alloy metal sheet around the perimeter of the hybrid battery cell enclosure; and
bonded to the aluminum alloy metal sheet around the perimeter of the hybrid battery cell enclosure by grafting of a triazine molecular layer therebetween.

11. The battery cell of claim 9, wherein the aluminum alloy metal sheet includes at least one flange portion that is folded over onto the multi-layer aluminum laminate film and extending at least partially along the perimeter of the hybrid battery cell enclosure.

12. The battery cell of claim 11, wherein the outer perimeter of the hybrid battery cell enclosure includes a segment wherein the aluminum alloy metal sheet does not include a flange portion folded over onto the multi-layer aluminum laminate film, such segment defining a vent.

13. The battery cell of claim 11, wherein the aluminum alloy metal sheet includes a first protruding element extending through the inner PP layer and into the middle layer of the multi-layer aluminum laminate film, creating an electrical circuit between the aluminum alloy metal sheet and the middle layer of the multi-layer aluminum laminate film.

14. The battery cell of claim 13, further including:
an anode current collector adjacent the anode layer and including an anode lead tab comprising one of graphite, carbon, silicone, tin, lithium or aluminum and extending between the aluminum alloy metal sheet and the multi-layer aluminum laminate film out of the sealed cavity;
a cathode current collector adjacent the cathode layer and including a cathode lead tab extending between the aluminum alloy metal sheet and the multi-layer aluminum laminate film out of the sealed cavity, the cathode lead tab including a cathode lead tab film including one of carbon black or conductive thermally stable polymer beads; and
the aluminum alloy metal sheet includes a second protruding element adapted to contact the cathode lead tab and creating a high resistance electrical circuit between the aluminum alloy metal sheet and the cathode lead tab.

15. The battery cell of claim 14, wherein the anode current collector and the anode lead tab are made from one of silicone or a lithium alloy, wherein the anode current collector and the anode lead tab will exhibit more severe expansion/compression during charging and discharging as compared to other materials, such as graphite.

16. A vehicle having at least one battery cell adapted to store electric energy for the vehicle, the hybrid battery cell comprising:
an anode layer having an anode lead tab comprising one of graphite, carbon, silicone, tin, lithium or aluminum, a cathode layer having a cathode lead tab and a separator positioned between the anode layer and the cathode layer, the anode layer, the cathode layer and the separator positioned within a hybrid battery cell enclosure having:
an aluminum alloy metal sheet; and
a multi-layer aluminum laminate film including an outer layer of plastic material, a middle layer comprising one of aluminum or an aluminum alloy, and an inner layer comprising polypropylene (PP);
wherein, the inner layer of the multi-layer aluminum laminate film and the aluminum alloy metal sheet are bonded to one another around a perimeter of the hybrid battery cell enclosure defining a sealed cavity between the multi-layer aluminum laminate film and the aluminum alloy metal sheet and within the perimeter of the hybrid battery cell, the anode layer, the cathode layer, and the separator positioned within the sealed cavity, and each of the anode lead tab and the cathode lead tab extending between the aluminum alloy metal sheet and the multi-layer aluminum laminate film out of the sealed cavity.

17. The vehicle of claim 16, wherein the inner layer of the multi-layer aluminum laminate film is at least one of:
heat-sealed to the aluminum alloy metal sheet around the perimeter of the hybrid battery cell enclosure; and
bonded to the aluminum alloy metal sheet around the perimeter of the hybrid battery cell enclosure by grafting of a triazine molecular layer therebetween.

18. The vehicle of claim 16, wherein the aluminum alloy metal sheet includes at least one flange portion that is folded over onto the multi-layer aluminum laminate film and extending at least partially along the perimeter of the hybrid battery cell enclosure, and the outer perimeter of the hybrid battery cell enclosure includes a segment wherein the aluminum alloy metal sheet does not include a flange portion folded over onto the multi-layer aluminum laminate film, such segment defining a vent.

19. The vehicle of claim 18, wherein the aluminum alloy metal sheet includes a first protruding element extending through the inner PP layer and into the middle layer of the multi-layer aluminum laminate film, creating an electrical circuit between the aluminum alloy metal sheet and the middle layer of the multi-layer aluminum laminate film.

20. The vehicle of claim 19, wherein the aluminum alloy metal sheet includes a second protruding element adapted to contact the cathode lead tab.
